(19) United States
(12) Patent Application Publication
(10) Pub. No.: US 2026/0083605 A1
(43) Pub. Date: Mar. 26, 2026

(54) AUXILIARY CHAIR

(71) Applicant: MERITS HEALTH PRODUCTS CO., LTD., Taichung City (TW)

(72) Inventors: Ming-Chuan CHENG, Taichung City (TW); Shun-Yuan CHENG, Taichung City (TW)

(21) Appl. No.: 19/195,741

(22) Filed: May 1, 2025

(30) Foreign Application Priority Data
Sep. 24, 2024 (TW) 113136186

(51) Int. Cl. A61G 5/10

(52) U.S. Cl. CPC A61G 5/10

(57) ABSTRACT

An auxiliary chair includes a chair body, a quick releasing structure, and a posture support structure. The posture support structure is connected to the quick releasing structure and includes at least two bars connected in series, two first joint modules and a second joint module. The two first joint modules are respectively connected to two ends of a first member of the bars, each of the first joint modules has a first rotatory axis, and the first rotatory axes are parallel to each other. The second joint module is connected to a distal end of a second member of the bars, and the second joint module has a second rotatory axis being orthogonal to each of the first rotatory axes. The quick releasing structure is operated to allow the posture support structure to rotate relative to the chair body or to separate from the chair body.

### RELATED APPLICATIONS

This application claims priority to Taiwan Application Serial Number 113136186, filed Sep. 24, 2024, which is herein incorporated by reference.

### BACKGROUND

### Technical Field

The present disclosure relates to an auxiliary chair. More particularly, the present disclosure relates to an auxiliary chair having a posture support structure.

### Description of Related Art

Disable people usually require auxiliary chairs such as wheel chairs owing to the disability of the body. The auxiliary chair generally includes a backrest and armrests for the user to rest thereon. However, for people who cannot keep balance by themselves, such as people with scoliosis, posture support structures have to be disposed at the backrest or two sides of the seat frame and are adjusted according to posture demands, thereby achieving an effect for supporting the body.

Nevertheless, as the user is going to leave the auxiliary chair, the posture support structures may block the way, which may bring inconvenience, and an improvement thereof is required.

### SUMMARY

According to one aspect of the present disclosure, an auxiliary chair includes a chair body, at least one quick releasing structure, and at least one posture support structure. The at least one quick releasing structure is connected to the chair body. The at least one posture support structure is connected to the at least one quick releasing structure and includes at least two bars connected in series, two first joint modules and a second joint module. The two first joint modules are respectively connected to two ends of a first member of the at least two bars, each of the first joint modules has a first rotatory axis, and the first rotatory axes of the two first joint modules are parallel to each other. The second joint module is connected to a distal end of a second member of the at least two bars, the distal end is far away from the first member, and the second joint module has a second rotatory axis being orthogonal to each of the first rotatory axes. As adjusting the at least one posture support structure, each of the first joint modules is switched from a limited state to an adjustable state for allowing the first member of the at least two bars to rotate. The at least one quick releasing structure is operated to allow the at least one posture support structure to rotate relative to the chair body or to separate from the chair body.

According to another aspect of the present disclosure, an auxiliary chair includes a chair body, at least one quick releasing structure, and at least one posture support structure. The at least one quick releasing structure is connected to the chair body. The at least one posture support structure is connected to the at least one quick releasing structure and includes at least two bars connected in series and comprising a connecting direction, two first joint modules and a second joint module. The two first joint modules are respectively connected to two ends of a first member of the at least two bars along the connecting direction, each of the first joint modules has a first rotatory axis, the first rotatory axes of the two first joint modules are parallel to each other, and each of the first joint modules includes two first face gears engaged with each other. The second joint module is connected to a distal end of a second member of the at least two bars, and the second joint module has a second rotatory axis being orthogonal to each of the first rotatory axes but parallel to the connecting direction. As adjusting the at least one posture support structure, each of the first joint modules is switched from a limited state to an adjustable state for allowing the first member of the at least two bars to rotate. The at least one quick releasing structure is operated to allow the at least one posture support structure to rotate relative to the chair body or to separate from the chair body.

### BRIEF DESCRIPTION OF THE DRAWINGS

The present disclosure can be more fully understood by reading the following detailed description of the embodiment, with reference made to the accompanying drawings as follows:

FIG. 1 is a partial three-dimensional schematic view of an auxiliary chair according to one embodiment of the present disclosure.

FIG. 2 is a three-dimensional schematic view of one posture support structure and one quick releasing structure of the auxiliary chair of the embodiment of FIG. 1.

FIG. 3 is an exploded view of the posture support structure and the quick releasing structure of the embodiment of FIG. 2.

FIG. 4 is a cross-sectional view of the posture support structure of the embodiment of FIG. 2 taken along line 4-4.

FIG. 5 is a cross-sectional view of the posture support structure and the quick releasing structure of the embodiment of FIG. 2 taken along line 5-5.

FIG. 6 is a three-dimensional schematic view of another posture support structure and another quick releasing structure of the auxiliary chair of the embodiment of FIG. 1.

FIG. 7 is an exploded view of the posture support structure and the quick releasing structure of the embodiment of FIG. 6.

FIG. 8 is a cross-sectional view of the posture support structure and the quick releasing structure of the embodiment of FIG. 6 taken along line 8-8.

FIG. 9 is one fragmentary view of the auxiliary chair of the embodiment of FIG. 1.

FIG. 10 is a three-dimensional schematic view of still another posture support structure and still another quick releasing structure of the auxiliary chair of the embodiment of FIG. 1.

FIG. 11 is another fragmentary view of the auxiliary chair of the embodiment of FIG. 1.

### DETAILED DESCRIPTION

It will be understood that when an element (or mechanism or module) is referred to as being “disposed on”, “connected to” or “coupled to” another element, it can be directly disposed on, connected or coupled to the other element, or intervening elements may also be present. In contrast, when an element is referred to as being “directly disposed on”, “directly connected to” or “directly coupled to” another element, there are no intervening elements present.

In addition, the terms first, second, third, etc. are used herein to describe various elements or components, these elements or components should not be limited by these terms. Consequently, a first element or component discussed below could be termed a second element or component.

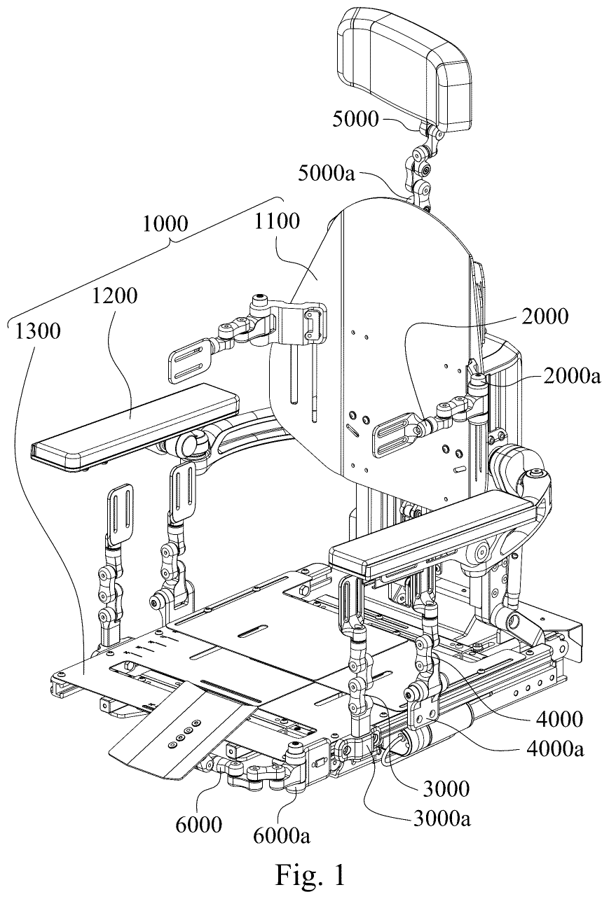

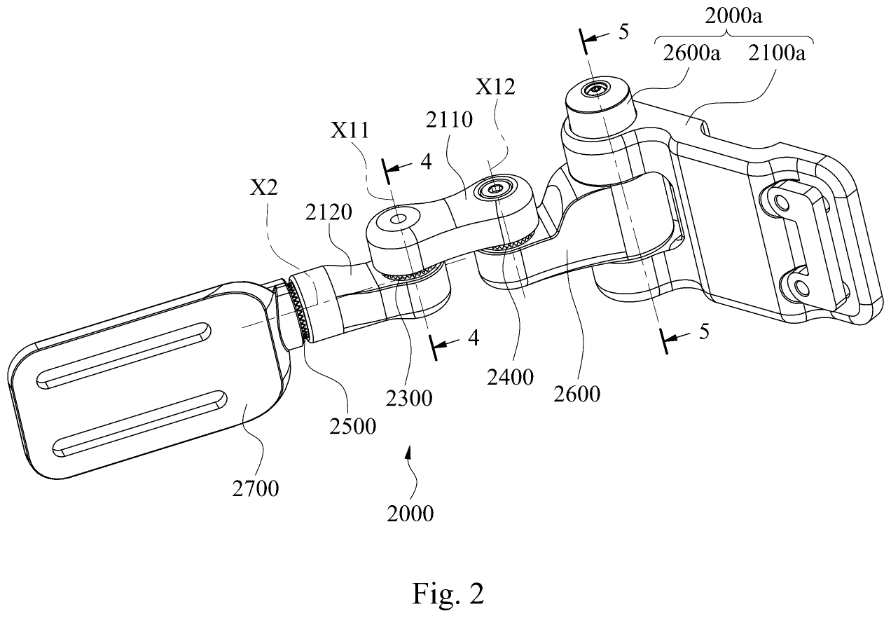

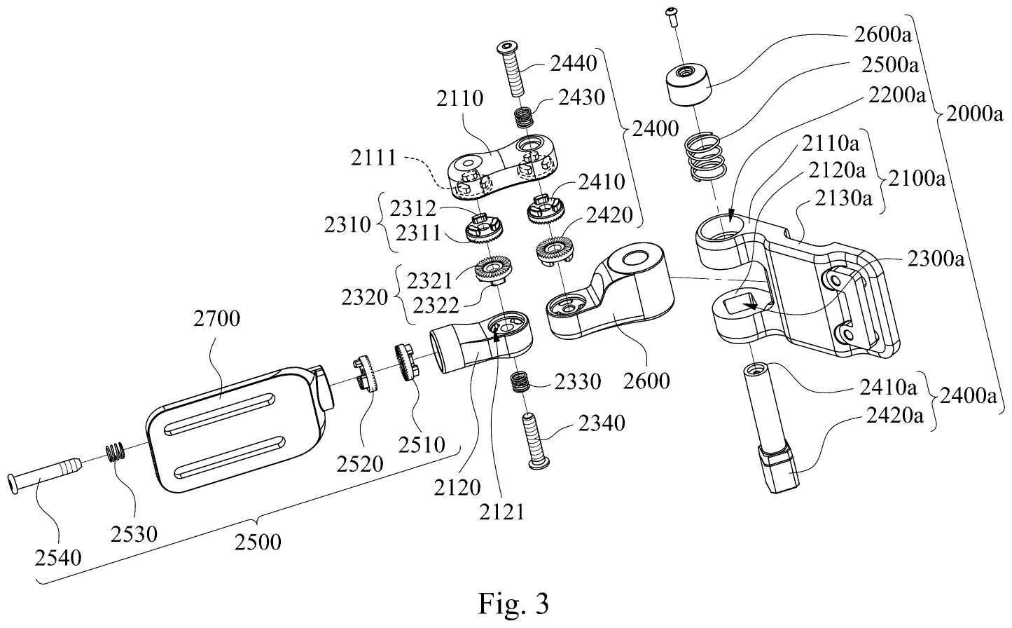

FIG. 1 is a partial three-dimensional schematic view of an auxiliary chair according to one embodiment of the present disclosure. FIG. 2 is a three-dimensional schematic view of one posture support structure 2000 and one quick releasing structure 2000a of the auxiliary chair of the embodiment of FIG. 1. FIG. 3 is an exploded view of the posture support structure 2000 and the quick releasing structure 2000a of the embodiment of FIG. 2. The auxiliary chair (not labeled) includes a chair body 1000, at least one quick releasing structure 2000a, 3000a, 4000a, 5000a, 6000a, and at least one posture support structure 2000, 3000, 4000, 5000, 6000. In the present embodiment, there are eight posture support structures 2000, 3000, 4000, 5000, 6000 and eight quick releasing structures 2000a, 3000a, 4000a, 5000a, 6000a. A number of the posture support structures 2000, a number of the posture support structures 3000 and a number of the posture support structures 4000 are two, and a number of the posture support structure 5000 and a number of the posture support structure 6000 are one, but the present disclosure is not limited thereto.

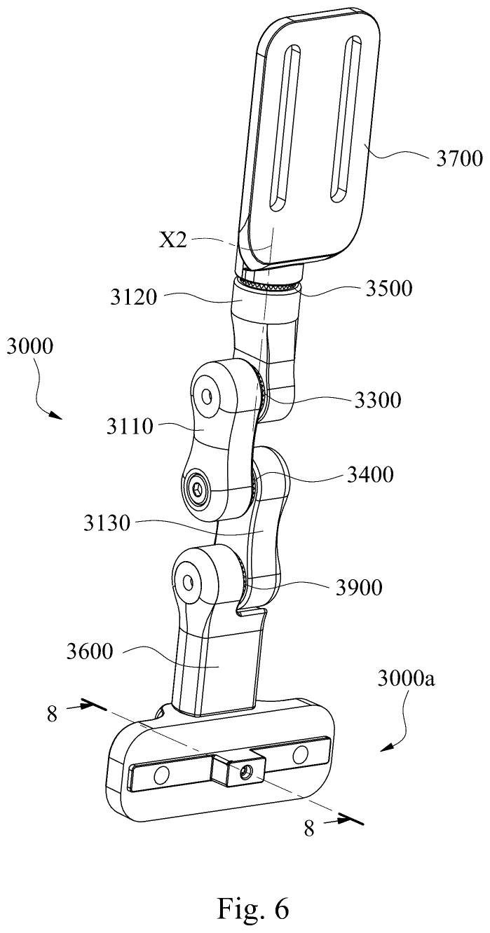

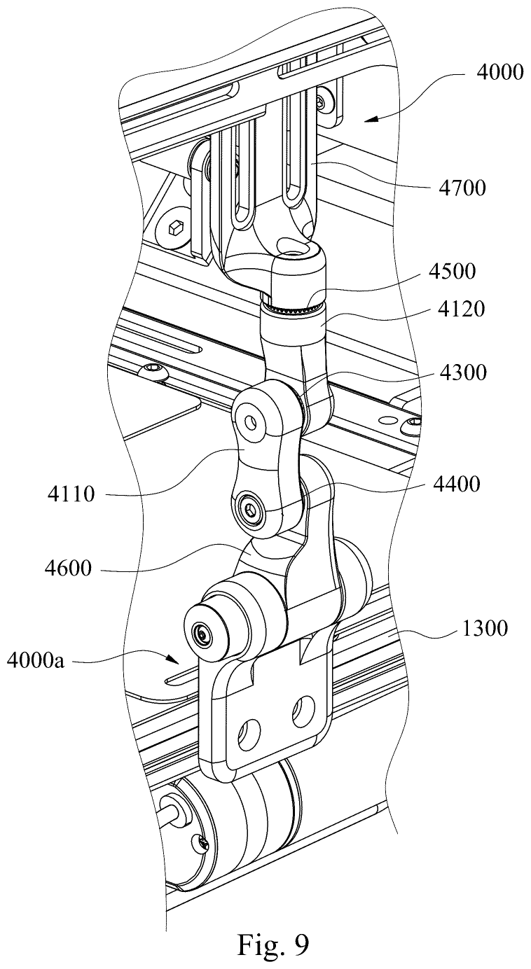

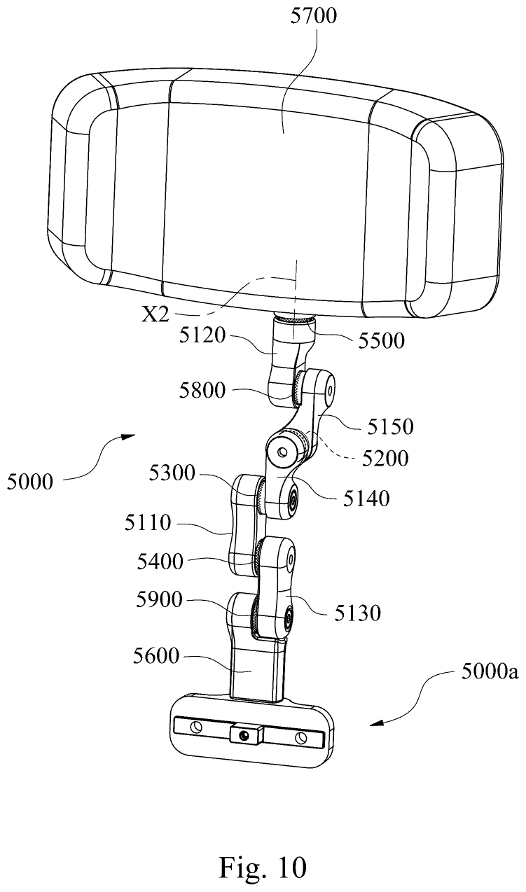

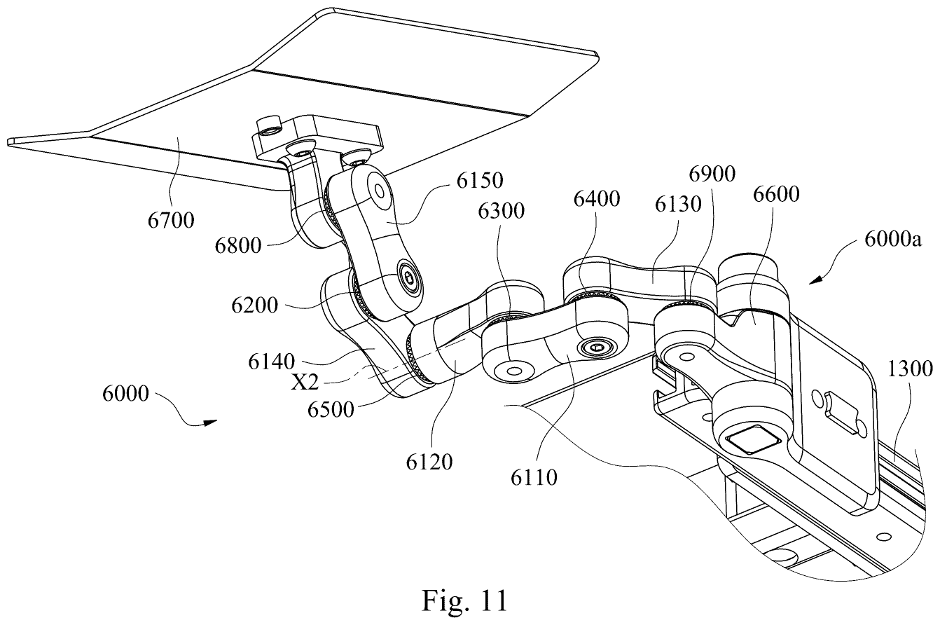

The eight quick releasing structures 2000a, 3000a, 4000a, 5000a, 6000a are connected to the chair body 1000. The eight posture support structures 2000, 3000, 4000, 5000, 6000 are respectively connected to the eight quick releasing structures 2000a, 3000a, 4000a, 5000a, 6000a. Each of the posture support structures 2000, 3000, 4000, 5000, 6000 includes at least two bars 2110, 2120, 3110 (labeled in FIGS. 6), 3120 (labeled in FIGS. 6), 3130 (labeled in FIGS. 6), 4110 (labeled in FIGS. 9), 4120 (labeled in FIGS. 9), 5110 (labeled in FIGS. 10), 5120 (labeled in FIGS. 10), 5130 (labeled in FIGS. 10), 5140 (labeled in FIGS. 10), 5150 (labeled in FIGS. 10), 6110 (labeled in FIGS. 11), 6120 (labeled in FIGS. 11), 6130 (labeled in FIG. 11) connected in series, two first joint modules 2300, 2400, 3300 (labeled in FIGS. 6), 3400 (labeled in FIGS. 6), 4300 (labeled in FIGS. 9), 4400 (labeled in FIGS. 9), 5300 (labeled in FIGS. 10), 5400 (labeled in FIGS. 10), 6300 (labeled in FIGS. 11), 6400 (labeled in FIG. 11), and a second joint module 2500, 3500 (labeled in FIGS. 6), 4500 (labeled in FIGS. 9), 5500 (labeled in FIGS. 10), 6500 (labeled in FIG. 11). The two first joint modules 2300, 2400, 3300, 3400, 4300, 4400, 5300, 5400, 6300, 6400 are respectively connected to two ends of a first member of the at least two bars 2110, 2120, 3110, 3120, 3130, 4110, 4120, 5110, 5120, 5130, 5140, 5150, 6110, 6120, 6130, each of the first joint modules 2300, 3300, 4300, 5300, 6300 has a first rotatory axis X11, each of the first joint modules 2400, 3400, 4400, 5400, 6400 has a first rotatory axis X12, and the first rotatory axes X11, X12 are parallel to each other. The second joint module 2500, 3500, 4500, 5500, 6500 is connected to a distal end of a second member of the at least two bars 2110, 2120, 3110, 3120, 3130, 4110, 4120, 5110, 5120, 5130, 5140, 5150, 6110, 6120, 6130, the distal end is far away from the first member, and the second joint module 2500, 3500, 4500, 5500, 6500 has a second rotatory axis X2 being orthogonal to each of the first rotatory axes X11, X12.

As adjusting each of the posture support structures 2000, 3000, 4000, 5000, 6000, each of the first joint modules 2300, 2400, 3300, 3400, 4300, 4400, 5300, 5400, 6300, 6400 is switched from a limited state to an adjustable state for allowing the first member of the at least two bars 2110, 2120, 3110, 3120, 3130, 4110, 4120, 5110, 5120, 5130, 5140, 5150, 6110, 6120, 6130 to rotate. Each of the quick releasing structure 2000a, 3000a, 4000a, 5000a, 6000a is operated to allow each of the posture support structures 2000, 3000, 4000, 5000, 6000 to rotate relative to the chair body 1000 or to separate from the chair body 1000.

Therefore, with the configuration that the quick releasing structures 2000a, 3000a, 4000a, 5000a, 6000a are operated to allow each of the posture support structures 2000, 3000, 4000, 5000, 6000 to rotate relative to the chair body 1000 or to separate from the chair body 1000, the user can easily leave the auxiliary chair.

It is noted that the auxiliary chair in the present embodiment may have a wheel chair structure and may further include a base and at least three wheels. The chair body 1000 may be disposed at the base, a number of the wheels may be four, and the wheels are disposed at the base. However, in order to clarify the drawings, the base and the wheels are omitted, and the present disclosure is not limited by the drawings. In other embodiments, the auxiliary chair may be a common chair and includes lags.

The chair body 1000 may include a backrest 1100, armrests 1200 and a seat frame 1300. The armrests 1200 and the seat frame 1300 are connected to the backrest 1100.

The two posture support structures 2000 may be respectively disposed at two sides of the backrest 1100, and are higher than the armrests 1200. When the user sits on the seat frame 1300, the posture support structures 2000 may support two side of user's the upper body, and may be adjustable to change the user's posture. Each of the posture support structures 2000 is coordinated with each of the quick releasing structures 2000a to achieve releasing or removing.

As shown in FIG. 2, a number of the bars 2110, 2120 is two. At this time the two bars 2110, 2120 are not pivoted relative to each other, and the bar 2110 and the bar 2120 form a line. Each of the bars 2110, 2120 is bar-shaped, and the two bars 2110, 2120 have a connecting direction parallel to the first rotatory axes X11, X12. The two first joint modules 2300, 2400 are respectively connected to two ends of the bar 2110, being the first member of the bars 2110, 2120, along the connecting direction.

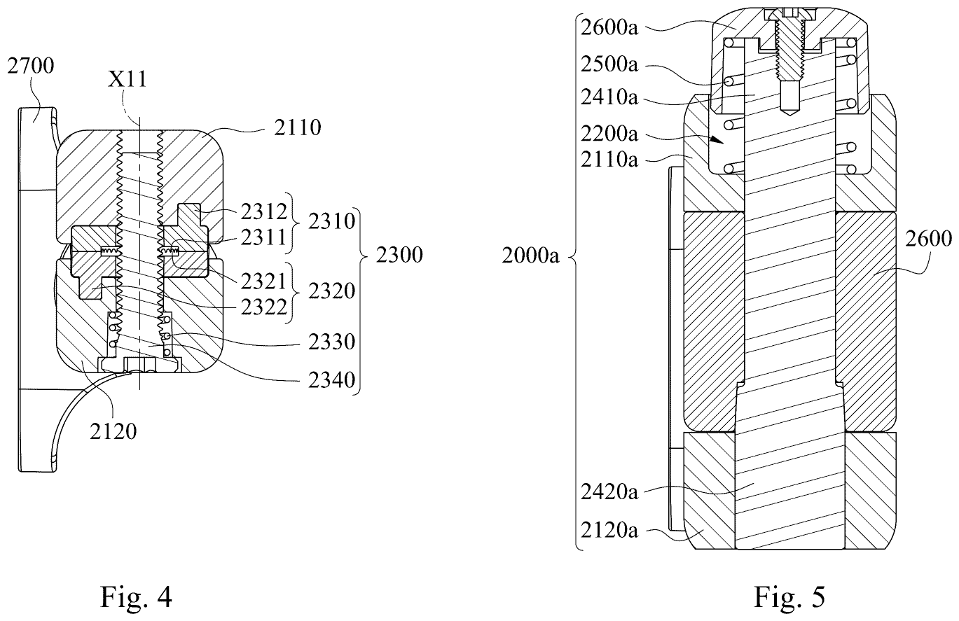

FIG. 4 is a cross-sectional view of the posture support structure 2000 of the embodiment of FIG. 2 taken along line 4-4. As shown in FIGS. 3 and 4, each of the first joint modules 2300, 2400 includes two first face gears 2310, 2320, 2410, 2420 engaged with each other. The two first face gears 2310, 2320 of the first joint module 2300 are respectively disposed at the bar 2110 and the bar 2120. Specifically, the first face gear 2310 includes a first face gear portion 2311 and three first engaging tabs 2312. The first face gear portion 2311 faces the bar 2120. The three first engaging tabs 2312 face the bar 2110. The bar 2110 may include three first engaging holes 2111 located at one of the ends, and with the engagement between the first engaging tabs 2312 and the first engaging holes 2111, the first face gear 2310 is rotatably restricted to the bar 2110. Similarly, the first face gear 2320 includes a first face gear portion 2321 and three first engaging tabs 2322. The bar 2120 may include three first engaging holes 2121 located at one of the ends, and with the engagement between the first engaging tabs 2322 and the first engaging holes 2121, the first face gear 2320 is rotatably restricted to the bar 2120.

The first joint module 2300 may further include a first spring 2330 and a first screw 2340. The bar 2120 may further include a spring hole (not labeled) and a screw hole (not labeled) comminuted to each other. The first spring 2330 may be received in the spring hole. The first screw 2340 may sequentially pass through the central hole of the first spring 2330, the screw hole, a gear hole of the first face gear 2320 and a gear hole of the first face gear 2310 to fasten into the bar 2110. Therefore, as the first screw 2340 is fastened tightly, the first face gear 2320 and the first face gear 2310 are firmly engaged to each other, and the bar 2110 and the bar 2120 cannot rotate relative to each other and are located in the limited state. On the contrary, as the first screw 2340 is loosened, a gap generated between the first face gear 2310 and the first face gear 2320, and the bar 2110 and the bar 2120 are located in the adjustable state. Therefore, the bar 2110 and the bar 2120 may rotate relative to each other to a required angle, and then the first screw 2340 may be fastened tightly again.

The posture support structure 2000 may further include a supporting board 2700. The structure of the second joint module 2500 is similar to the structure of the first joint module 2300, and the second joint module 2500 includes two second face gears 2510, 2520, a second spring 2530 and a second screw 2540. The bar 2120 is defined as the second member of the bars 2110, 2120. The second face gear 2510 may be rotatably restricted to the bar 2120. The second face gear 2520 may be rotatably restricted to the supporting board 2700. The second screw 2540 is screwed to the bar 2120 and the supporting board 2700. Precisely, the bar 2120 has two ends with different shapes, one is a circular end, being far away from the bar 2110, having an axis parallel to the connecting direction of the bar 2110, and the other is a board end having a plane facing the bar 2110 for connecting the first face gear 2320. Hence, the second rotatory axis X2 is orthogonal to the first rotatory axes X11, X12 and is parallel to the connecting direction.

The posture support structure 2000 may further include a disposing bar 2600 connected to the first joint module 2400. The disposing bar 2600 has two ends with different shapes, one is a tube end having an axis orthogonal to the connecting direction of the disposing bar 2600 and parallel to the first rotatory axes X11, X12, the other one is a board end having a plane facing the bar 2110. The first joint module 2400 may also include two first face gears 2410, 2420, a first spring 2430 and a first screw 2440. The first face gear 2410 is rotatably restricted to the bar 2110, the first face gear 2420 is rotatably restricted to the board end of the disposing bar 2600, and the first screw 2440 is fastened with the bar 2110 and the disposing bar 2600.

FIG. 5 is a cross-sectional view of the posture support structure 2000 and the quick releasing structure 2000a of the embodiment of FIG. 2 taken along line 5-5. Please refer to FIG. 5 with references of FIGS. 1 to 4, the quick releasing structure 2000a may include a first mounting bracket 2100a connected to the chair body 1000 and including two arms 2110a, 2120a spaced apart from each other, a pivoting hole 2200a penetrating one of the two arms 2110a, 2120a along a first penetrating direction parallel to each of the first rotatory axes X11, X12, a pin hole 2300a penetrating another one of the two arms 2110a, 2120a along the first penetrating direction, a positioning pin 2400a insertably disposed at the disposing bar 2600 of the posture support structure 2000 and is assembled with the first mounting bracket 2100a, and a first elastic element 2500a. The positioning pin 2400a includes a pressed end 2410a and a limiting end 2420a, the pressed end 2410a is received in the pivoting hole 2200a, the limiting end 2420a corresponds to the pin hole 2300a, and a shape of the limiting end 2420a matches a shape of the pin hole 2300a. The first elastic element 2500a sleeves at the pressed end 2410a. After an external force is exerted on the pressed end 2410a, the pressed end 2410a pushes the limiting end 2420a to separate from the posture support structure 2000, and the first elastic element 2500a stores a restoring force, thereby allowing the posture support structure 2000 to rotate relative to the first mounting bracket 2100a, and after the external force is removed, the pressed end 2310a is restored by the restoring force of the first elastic element 2500a, and the limiting end 2420a returns and prohibits the posture support structure 2000 from rotating.

To be more specific, the first mounting bracket 2100a may include a fastening portion 2130a. The arms 2110a, 2120a extend from one end of the fastening portion 2130a, and a gap between the two arms 2110a, 2120a may be provided for the tube end of the disposing bar 2600 to inserts thereinto. The pivoting hole 2200a is located at the arm 2110a, and includes a first segment and a second segment. A diameter of the first segment is larger than a diameter of the second segment. The first elastic element 2500a may be located in the first segment with one end abutted against a step between the first segment and the second segment.

A diameter of the pressed end 2410a is slightly smaller than the diameter of the second segment of the pivoting hole 2200a, and can pass the second segment to enter the first segment and be sleeved by the first elastic element 2500a. The limiting end 2420a and the pin hole 2300a are both rectangular shaped and are rotatably restricted to each other. In other words, the limiting end 2420a cannot rotate relative to the pin hole 2300a. As the positioning pin 2400a passes into the pivoting hole 2200a from the pin hole 2300a, the positioning pin 2400a passes through the pin hole 2300a, the tube end of the disposing bar 2600 and the pivoting hole 2200a sequentially. Therefore, the disposing bar 2600 is connected to the first bracket 2100a. Moreover, a hole of the disposing bar 2600 located at the tube end may include an anti-rotation segment and a rotation segment. The anti-rotation segment is near the pin hole 2300a and fits the shape of the limiting end 2420a. Consequently, as the positioning pin 2400a is located in the anti-rotation segment, the positioning pin 2400a is rotatably restricted to the disposing bar 2600.

The quick releasing structure 2000a may further include a cap 2600a and a faster (not labeled). A diameter of the cap 2600a is smaller than the diameter of the first segment and the cap 2600a covers on the pressed end 2410a. The cap 2600a may accommodate the other end of the first elastic element 2500a, and the faster is fastened into the pressed end 2410a and the cap 2600a.

As shown in FIG. 5, the quick releasing structure 2000a is not operated. The limiting end 2420a of the positioning pin 2400a is located in the anti-rotation segment, the disposing bar 2600 cannot rotate relative to the first bracket 2100a and the posture support structure 5000 is in a fixing state to support the user stably. One the contrary, as there is a requirement to release the posture support structure 2000, the user may press the cap 2600a to push the positioning pin 2400a to move along the first penetrating direction to separate from the anti-rotation segment, and the disposing bar 2600 will not be restricted by the positioning pin 2400a and can rotate freely. Hence, the posture support structure 2000 may change position by pushing and will not block the way of the user, which may bring using convenience. After the user releases the cap 2600a, the restoring force of the first elastic element 2500a allows the positioning pin 2400a to be restored, and the posture support structure 2000 return to the fixing state.

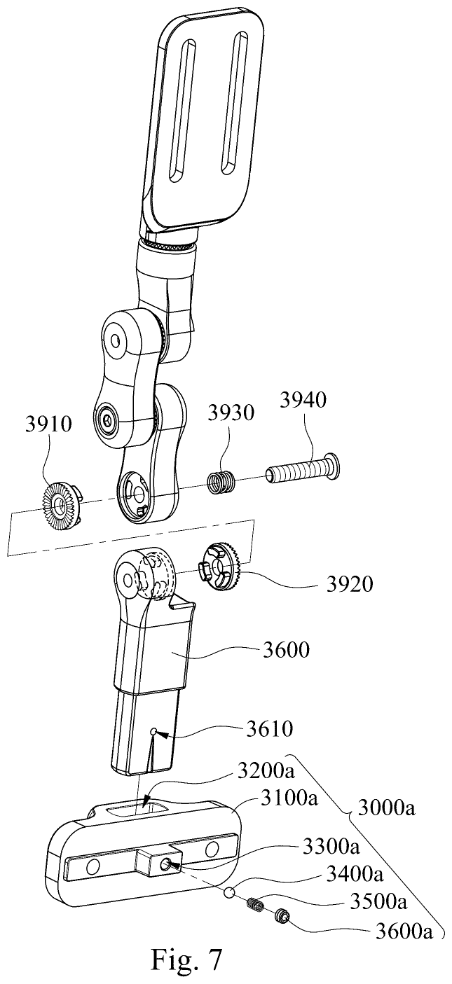

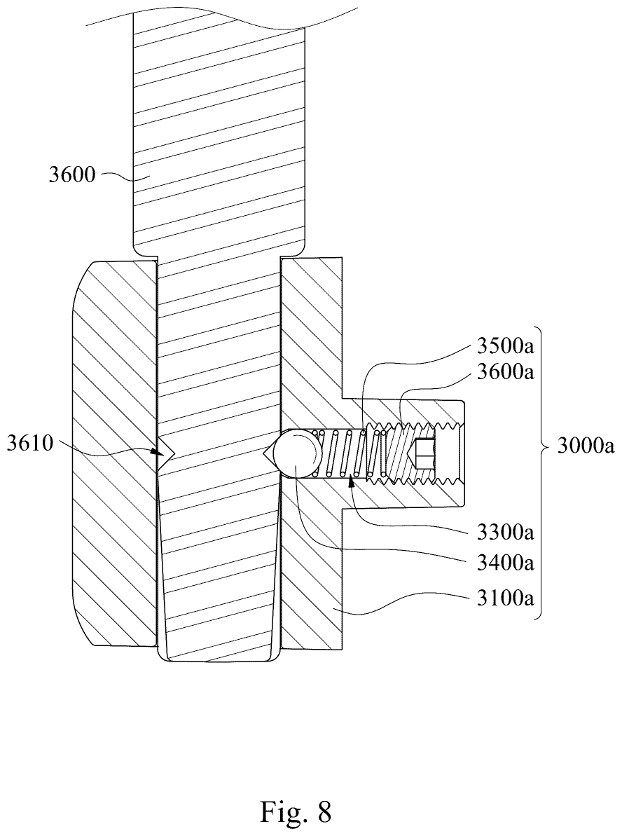

FIG. 6 is a three-dimensional schematic view of another posture support structure 3000 and another quick releasing structure 3000a of the auxiliary chair of the embodiment of FIG. 1. FIG. 7 is an exploded view of the posture support structure 3000 and the quick releasing structure 3000a of the embodiment of FIG. 6. FIG. 8 is a cross-sectional view of the posture support structure 3000 and the quick releasing structure 3000a of the embodiment of FIG. 6 taken along line 8-8. The two posture support structures 3000 are respectively disposed at the two sides of the seat frame 1300. The two first joint modules 3300, 3400, the second joint module 3500 and a supporting board 3700 of the posture support structure 3000 are similar to the two first joint modules 2300, 2400, the second joint module 2500 and the supporting board 2700 of the posture support structure 2000, but a number of bars 3110, 3120, 3130 of the posture support structure 3000 is three, and the bar 3120, the bar 3110 and the bar 3130 which is defined as a third member are arranged from an upper side to the a lower side in order. The posture support structure 3000 may further include a third joint module 3900 and a disposing bar 3600, the third joint module 3900 is connected to the bar 3130, and the disposing bar 3600 is connected to the third joint module 3900.

Specifically, the structure of the bar 3130 is similar to the structure of the bar 3110, and the bar 3130 is connected to the bar 3110 via the first joint module 3400. The disposing bar 3600 has two ends with different shapes, one is a protruding end, and the other one is a lever end. The disposing bar 3600 may further include a positioning cavity 3610 located at the lever end. The protruding end may be fastened with the bar 3130 via the third joint module 3900. Precisely, the structure of the third joint module 3900 is similar to the structure of the first joint module 3300 and includes two third face gears 3910, 3920, a third spring 3930 and a third screw 3940. The third face gear 3910 is disposed at the bar 3130, the third face gear 3920 is disposed at the disposing bar 3600, and the third screw 3940 is fastened with the bar 3130 and the disposing bar 3600.

The quick releasing structure 3000a may include a second mounting bracket 3100a connected to the chair body 1000, an inserting groove 3300a penetrating the second mounting bracket 3100a along a second direction parallel to the second rotatory axis X2, a positioning groove 3300a disposed at the second mounting bracket 3100a and communicated with the inserting groove 3200a, a second elastic element 3500a received in the positioning groove 3200a, and a ball 3400a pushed by the second elastic element 3500a to abut against the posture support structure 3000. A positioning axis (not labeled) of the positioning groove 3300a is orthogonal to the second penetrating direction. The lever end of the disposing bar 3600 may be used to insert the inserting groove 3200a. The positioning cavity 3610 of the disposing bar 3600 may be a tapered hole corresponding to the ball 3400a.

As shown in FIGS. 7 and 8, the second mounting bracket 3100a may include a main portion (not labeled) and a projection (not labeled) connected integrally to the main body. The inserting groove 3200a penetrates the main portion, the positioning groove 3300a extends from the projection toward the main portion to be communicated with the inserting groove 3200a. The shape of the inserting groove 3200a corresponds to the shape of the lever end of the disposing bar 3600, and thus the inserting groove 3200a is rotatably restricted to the lever end. One side of the positioning groove 3300a which moves close to the inserting groove 3200a may include a stopping projection (not labeled) for preventing the ball 3400a from falling into the inserting groove 3200a. The quick releasing structure 3000a may further include a blocker 3600a configured to fasten into the positioning groove 3300a to prevent the ball 3400a and the second elastic element 3500a from separating.

Since the positioning cavity 3610 is a tapered hole, the cross-section thereof in FIG. 8 is a triangle including a pushing surface. If the user would like to remove the posture support structure 3000, a force may be exerted on the posture support structure 3000 to pull the posture support structure 3000 upward, the pushing surface below the ball 3400a may then push the ball 3400a, and the ball 3400a will compress the second elastic element 3500a toward the left side of FIG. 8 (compressing along the positioning axis). Accordingly, the ball 3400a is disengaged from the positioning cavity 3610 and the posture support structure 3000 is allowed to be removed. On the contrary, if the user would like to install the posture support structure 3000, the lever end of the disposing bar 3600 may be inserted into the inserting groove 3200a, a guiding groove (not labeled) may guide the ball 3400a to move inward and be engaged with the positioning cavity 3610 again. It is noted that, a number of the positioning cavities and a number of the guiding grooves may be two, the positioning cavities are symmetrically disposed at two sides of the lever end, the guiding grooves are symmetrically disposed at the two sides of the lever end, and thus the disposing bar 3600 may be installed from any of two directions to increase the using convenience, but the present disclosure is not limited thereto.

FIG. 9 is one fragmentary view of the auxiliary chair of the embodiment of FIG. 1. The two posture support structures 4000 are respectively disposed at the two sides of the seat frame 1300. Each of the two posture support structures 4000 is spaced apart from the posture support structures 3000 located at the same side. The two bars 4110, 4120, the two first joint modules 4300, 4400, the second joint module 4500, a disposing bar 4600 and a supporting board 4700 of the posture support structure 4000 are similar to the two bars 2110, 2120, the two first joint modules 2300, 2400, the second joint module 2500, the disposing bar 2600 and the supporting board 2700 of the posture support structure 2000, the quick releasing structure 4000a is similar to the quick releasing structure 2000a, and the details will not be repeated. However, the difference is that the shape and length of the first mounting bracket (not labeled) of the quick releasing structure 4000a are different from the shape and length of the first mounting bracket 2100a of the quick releasing structure 2000a.

FIG. 10 is a three-dimensional schematic view of still another posture support structure 5000 and still another quick releasing structure 5000a of the auxiliary chair of the embodiment of FIG. 1. The posture support structure 5000 is disposed at an upper end of the backrest 1100. The two first joint modules 5300, 5400, the second joint module 5500, a disposing bar 5600 and a third joint module 5900 of the posture support structure 5000 are similar to the two first joint modules 3300, 3400, the second joint module 3500, the disposing bar 3600 and the third joint module 3900 of the posture support structure 3000, the quick releasing structure 5000a is similar to the quick releasing structure 3000a, and the details will not be repeated. However, the posture support structure 5000 further includes a headrest 5700, a fourth joint module 5200 and a fifth joint module 5800, and a number of bars 5110, 5120, 5130, 5140, 5150 is five. The bar 5130, the bar 5110, the bar 5140, the bar 5150 and the bar 5120 are connected from the disposing bar 5600, being from the upper side to the lower side, in order. The bar 5110 is connected to the bar 5140 via the first joint module 5300, the bar 5140 is connected to the bar 5150 via the fourth joint module 5200, the bar 5150 is connected to the bar 5120 via the fifth joint module 5800, and the bar 5120 is connected to the headrest 5700 via the second joint module 5500. A fourth rotatory axis is orthogonal to the first rotatory axis and the second rotatory axis X2, and a fifth rotatory axis of the fifth joint module 5800 is parallel to the first rotatory axis. Therefore, the headrest 5700 may pitch and yaw.

FIG. 11 is another fragmentary view of the auxiliary chair of the embodiment of FIG. 1. The posture support structures 6000 are respectively disposed at the two sides of the seat frame 1300. The two first joint modules 6300, 6400 and the second joint module 6500 of the posture support structure 6000 are similar to the two first joint modules 2300, 2400 and the second joint module 2500 of the posture support structure 2000, the quick releasing structure 6000a is similar to the quick releasing structure 2000a, and the details will not be repeated. A number of the bars 6110, 6120, 6130 is three, and the posture support structure 6000 further includes two converting bars 6140, 6150, a disposing bar 6600, a third joint module 6900, a fourth joint module 6200, a fifth joint module 6800 and a footrest 6700. The bar 6130, the bar 6110 and the bar 6120 are connected from the disposing bar 6600 in order. The bar 6130 is connected to the disposing bar 6600 via the third joint module 6900, the bar 6110 is connected to the bar 6120 and the bar 6130 via the first joint modules 6300, 6400, the bar 6120 is connected to the converting bar 6140 via the second joint module 6500, the converting bar 6140 is connected to the converting bar 6150 via the fourth joint module 6200, and the converting bar 6150 is connected to the footrest 6700 via the fifth joint module 6800. A fourth rotatory axis of the fourth joint module 6200 and a fifth rotatory axis of the fifth joint module 6800 are parallel to the second rotatory axis X2.

With the aforementioned embodiments, the posture support structure may be disposed at any position of the auxiliary chair, include different components such as supporting bard, headrest and footrest to support different portions of the user, and include joint modules and bars to adjust the angles. A number of the bars may be decided based on the demands, and other components such as converting bars may be used to achieve more adjustments of the angles. In addition, with the quick releasing structure, no extra tool is required to remove the posture support structure or to rotate the posture support structure to a position which does not block the way of the user, which may bring using convenience.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An auxiliary chair, comprising:
a chair body;
at least one quick releasing structure connected to the chair body; and
at least one posture support structure connected to the at least one quick releasing structure and comprising:
at least two bars connected in series;
two first joint modules respectively connected to two ends of a first member of the at least two bars, each of the first joint modules having a first rotatory axis, wherein the first rotatory axes of the two first joint modules are parallel to each other; and
a second joint module connected to a distal end of a second member of the at least two bars, the distal end being far away from the first member, the second joint module having a second rotatory axis being orthogonal to each of the first rotatory axes;
wherein as adjusting the at least one posture support structure, each of the first joint modules is switched from a limited state to an adjustable state for allowing the first member of the at least two bars to rotate; the at least one quick releasing structure is operated to allow the at least one posture support structure to rotate relative to the chair body or to separate from the chair body.

2. The auxiliary chair of claim 1, wherein the at least one quick releasing structure comprises:
a first mounting bracket connected to the chair body and comprising two arms spaced apart from each other;
a pivoting hole penetrating one of the two arms along a first penetrating direction parallel to each of the first rotatory axes;
a pin hole penetrating another one of the two arms along the first penetrating direction;
a positioning pin insertably disposed at the at least one posture support structure and assembled with the first mounting bracket, the positioning pin comprising a pressed end and a limiting end, wherein the pressed end is received in the pivoting hole, the limiting end corresponds to the pin hole, and a shape of the limiting end matches a shape of the pin hole; and
a first elastic element sleeving at the pressed end;
wherein after an external force is exerted on the pressed end, the pressed end pushes the limiting end to separate from the at least one posture support structure and the first elastic element stores a restoring force, thereby allowing the at least one posture support structure to rotate relative to the first mounting bracket, and after the external force is removed, the pressed end is restored by the restoring force of the first elastic element, and the limiting end returns and prohibits the at least one posture support structure from rotating.

3. The auxiliary chair of claim 2, wherein the at least one posture support structure further comprises:
a disposing bar connected to one of the two first joint modules;
Wherein the positioning pin of the at least one quick releasing structure is insertably disposed at the disposing bar.

4. The auxiliary chair of claim 1, wherein the at least one quick releasing structure comprises:
a second mounting bracket connected to the chair body;
an inserting groove penetrating the second mounting bracket along a second direction parallel to the second rotatory axis;
a positioning groove disposed at the second mounting bracket and communicated with the inserting groove, a positioning axis of the positioning groove is orthogonal to the second penetrating direction;
a second elastic element received in the positioning groove; and
a ball pushed by the second elastic element to abut against the at least one posture support structure.

5. The auxiliary chair of claim 4, wherein a number of the at least two bars is larger than or equal to three, the second member, the first member and a third member of the bars are connected in order, and the at least one posture support structure further comprises:
a third joint module connected to the third member of the bars; and
a disposing bar connected to the third joint module and inserted into the inserting groove, the disposing bar comprising a positioning cavity corresponding to the ball of the at least one quick releasing structure.

6. An auxiliary chair, comprising:
a chair body;
at least one quick releasing structure connected to the chair body; and
at least one posture support structure connected to the at least one quick releasing structure and comprising:
at least two bars connected in series and comprising a connecting direction;
two first joint modules respectively connected to two ends of a first member of the at least two bars along the connecting direction, each of the first joint modules having a first rotatory axis, wherein the first rotatory axes of the two first joint modules are parallel to each other, and each of the first joint modules comprises two first face gears engaged with each other; and
a second joint module connected to a distal end of a second member of the at least two bars, the second joint module having a second rotatory axis being orthogonal to each of the first rotatory axes but parallel to the connecting direction;
wherein as adjusting the at least one posture support structure, each of the first joint modules is switched from a limited state to an adjustable state for allowing the first member of the at least two bars to rotate; the at least one quick releasing structure is operated to allow the at least one posture support structure to rotate relative to the chair body or to separate from the chair body.

7. The auxiliary chair of claim 6, wherein the at least one quick releasing structure comprises:
a first mounting bracket connected to the chair body and comprising two arms spaced apart from each other;
a pivoting hole penetrating one of the two arms along a first penetrating direction parallel to each of the first rotatory axes;
a pin hole penetrating another one of the two arms along the first penetrating direction;
a positioning pin insertably disposed at the at least one posture support structure and assembled with the first mounting bracket, the positioning pin comprising a pressed end and a limiting end, wherein the pressed end is received in the pivoting hole, the limiting end corresponds to the pin hole, and a shape of the limiting end matches a shape of the pin hole; and
a first elastic element sleeving at the pressed end;
wherein after an external force is exerted on the pressed end, the pressed end pushes the limiting end to separate from the at least one posture support structure and the first elastic element stores a restoring force, thereby allowing the at least one posture support structure to rotate relative to the first mounting bracket, and after the external force is removed, the pressed end is restored by the restoring force of the first elastic element, and the limiting end returns and prohibits the at least one posture support structure from rotating.

8. The auxiliary chair of claim 7, wherein the at least one posture support structure further comprises:
a disposing bar connected to one of the two first joint modules;
wherein the positioning pin of the at least one quick releasing structure is insertably disposed at the disposing bar.

9. The auxiliary chair of claim 6, wherein the at least one quick releasing structure comprises:
a second mounting bracket connected to the chair body;
an inserting groove penetrating the second mounting bracket along a second direction parallel to the second rotatory axis;
a positioning groove disposed at the second mounting bracket and communicated with the inserting groove, a positioning axis of the positioning groove is orthogonal to the second penetrating direction;
a second elastic element received in the positioning groove; and
a ball pushed by the second elastic element to abut against the at least one posture support structure.

10. The auxiliary chair of claim 9, wherein a number of the at least two bars is larger than or equal to three, the second member, the first member and a third member of the bars are connected in order, the at least one posture support structure further comprises:
a third joint module connected to the third member of the bars; and
a disposing bar connected to the third joint module and inserted into the inserting groove, the disposing bar comprising a positioning cavity corresponding to the ball of the at least one quick releasing structure.
